(19) United States
(12) Patent Application Publication
(10) Pub. No.: US 2010/0201309 A1
(43) Pub. Date: Aug. 12, 2010

(54) SYSTEMS AND METHODS FOR COUPLING A VEHICLE TO AN EXTERNAL GRID AND/OR NETWORK

(76) Inventor: Ivan C. Meek, Louisville, CO (US)

Correspondence Address: HOLLAND & HART, LLP, P.O BOX 8749, DENVER, CO, 80201, US

(21) Appl. No.: 12/368,920

(22) Filed: Feb. 10, 2009

(51) Int. Cl. H02J 7/00; G06F 7/00; G05B 15/02

(52) U.S. Cl. 320/108; 320/107; 320/128; 701/1; 701/2; 700/275

(57) ABSTRACT

Vehicle charging apparatuses and methods connect a vehicle to an external power source, the vehicle having a battery that is capable of being charged from the external power source and having a receptacle configured to receive a plug connected to the external power source. An alignment target receives at least one visual alignment beam from a vehicle, the position of the alignment beam providing visual indication to a vehicle operator that the vehicle is properly aligned relative to the charging station. A robotic arm is mounted to a structure and has a plug at a distal end thereof, the plug interconnected to the external power source and adapted to engage the vehicle receptacle to transfer power to or from the vehicle. A module may be provided for controlling the robotic arm such that said plug engages with the vehicle receptacle when the vehicle is properly aligned to receive the plug.

### FIELD

This disclosure relates to coupling of vehicles to a network and/or grid external to the vehicle, and more specifically to charging stations having positioning assistance and magnetic inductive couplings used for transferring energy to and from a vehicle battery.

### BACKGROUND

An abundant supply of fossil fuels has powered the industrial revolution of the past two hundred years. The supply of those fuels is being depleted, and consideration of alternative sources of energy has become more prevalent. In addition, the burning of the carbon in those fuels has contaminated the atmosphere, oceans, and soil with carbon dioxide and other pollutants. These fossil fuels are widely used in different forms to furnish electricity, heat homes, fuel vehicles, and power commerce in general, thus complicating the search for replacements.

Various alternatives are known and are being considered in some form to help displace the amount of energy produced using fossil fuels. For example, nuclear energy is an alternative source of electrical energy but suffers from high cost, difficult waste disposal, safety issues, and energy efficiency issues. Biofuels are another alternative and have the advantage that burning of such fuels does not add new carbon dioxide to the environment. Unfortunately, it is not realistic to produce enough biofuel to replace the amount of petroleum currently used. The United States National Renewal Energy Laboratory (NREL) estimates we use about 100 million barrels of ethanol a year compared to nearly 7 billion barrels of oil. Hydrogen is being explored as another alternative to traditional fossil fuels, although various technical hurdles will prevent widespread use of such a fuel for many years, at a minimum.

Electricity generation from solar and wind sources is a relatively developed technology, and possibly the best option for displacing fossil fuel as an energy source in the near term. Of the different sources of renewable energy, only wind and solar are sufficiently abundant to completely replace fossil fuels. However, neither can be easily converted into a liquid fuel, both are intermittent and are not available “on-demand,” and are thus often supplements to existing centralized power plants. Solar and wind are, however, available in enough abundance that they could replace all other sources of electrical energy generation if the fluctuations could be leveled with energy storage facilities. Furthermore, powering transportation with electricity could drastically reduce carbon emitting fossil energy sources.

Transportation that is powered from electricity would require electric vehicles or, alternatively, hybrid vehicles that operate using both liquid fuel and stored electricity. Such hybrid vehicles are commonly referred to as “plug-in hybrids” in that the vehicle is “plugged in” to the existing power grid to charge on-board batteries that are used to drive an electric motor in the vehicle. In the event that the charge in the on-board battery of such a plug-in hybrid is depleted, a separate gasoline (or other liquid fuel) engine is engaged to either power the vehicle or provide power to the electric motor of the vehicle.

Currently there are no mass produced plug-in hybrid automobiles. In the United States, most existing low volume and prototype plug-in electric vehicles use a variation of the standard extension cord, illustrated by FIG. 1. These low production US vehicles are generally charged by the universally available 60-Hertz, 120 Volt household power. These connections are limited to a maximum of 15 Amps of current. While conveniently available, this voltage source is not an ideal match to the high frequency, high voltage motor drive components. Sixty-Hertz, 120-Volt household power cannot be used directly in the vehicle and the 60-Hertz components for converting this voltage are heavy and expensive. Further, this arrangement is not inherently bi-directional. If the stored vehicle power is to be available externally, transfer relays are needed as well as a 60-Hertz power inverter. A 60-Hertz, 120-Volt inverter is unneeded elsewhere in the vehicle and is another undesired, expensive subsystem.

Such connections also require metallic contacts of conductive connectors, which are subject to wear and corrosion. Films from oily vapors or other sources can contaminate the metallic contacts, adding a further disadvantage for such connections. The conductive connector injects the charging voltage into the vehicle without isolation, and additional isolation insulation must be provided within the vehicle, which can be difficult to do because of the amount of wiring. If the isolation breaks down, it poses a safety hazard, for example, standard 60-Hertz household voltages can fatally electrocute humans.

The relatively low power available from 60-Hertz household receptacles is inadequate to rapidly charge the high capacity battery of a plug-in hybrid vehicle. Even if the 60-Hertz voltage is raised to speed charging, the connectors with metallic contacts must operate at a specified voltage if there is a universal standard. This imposed standard voltage may not be convenient in the future as the technology progresses, and this could force the vehicle designer to compromise the electrical design or make obsolete the existing base of battery chargers.

Another method for charging batteries is through inductive coupling, which can provide an improvement over metallic contacts. This is not a new concept, and was used, for example, on General Motor's electric vehicle, the EV-1. The battery charger and inductive connection for the EV-1 was called the Magnecharger, illustrated as FIG. 2. The coupling was in the form of a paddle connected to a standalone battery charger by a two-meter long cord. The EV-1 was project was ultimately abandoned with all of the vehicles withdrawn from the market and crushed.

A fundamental problem with the EV-1 was the requirement for a person to manually remove the paddle from the charger and insert the plug into a slot at the front of the vehicle. The car had to be parked far enough away from the charger to allow room to walk between the vehicle and the charger, wasting space in the garage or parking space. The Magnecharger included no aid to judge the vehicle position. This means that if parked improperly, the cord would not reach the charging slot, or the operator would rub clothing against the car, or, if parked too far away from the charger, would not be able to close the garage door.

A further disadvantage of the Magnecharger was the need for 230-Volt, 60-Hertz service at 20 Amps. The 230-Volt service is usually not conveniently available and often requires the services of an electrician. The Magnecharger itself was expensive; it was over several thousand dollars because it contained a costly, high power switching inverter. The maximum power available from 230-V, 20-Amp service is 4,600 Watts. At this power level it takes several hours to fully charge a battery powered vehicle capable of a 40 mile or greater range. If the vehicle is parked for the night this is plenty of time for charging. If, however, the vehicle is parked for a lunch stop on a long trip, a faster charge time is desirable. The Lithium-Ion batteries slated for advanced hybrids are capable of very fast charge times, in the order of minutes. The charge time is considerably reduced if the connection is capable of higher power levels. A further disadvantage of the paddle configuration is the narrow tolerance between the sides of the paddle and the mating vehicle magnetic structure. If heating causes parts of the structure to expand, the gap could widen, drastically reducing efficiency and power transfer capability. If the gap narrows from heating, or if debris drops into the slot, the paddle could jam in the charging slot. The gap must be narrow to maintain the full magnetic flux density.

### SUMMARY

Various aspects of the disclosure provide charging plugs for a vehicle battery using magnetic induction in lieu of metallic contacts. Embodiments described herein provide inherent advantages of an inductive coupler, such as no exposed contacts that could provide a safety hazard; no exposed metal to corrode, wear, or become contaminated; low or no force to mate, simplifying plugging-in; inherent isolation the vehicle electronics from the charger.

Embodiments described here are designed to operate with high frequency AC, reducing or eliminating disadvantages of 60-Hertz components. Inductive coupling provided herein has no exposed contacts, reducing the shock hazard associated with charging as compared to a charger that has exposed metal contacts. Another advantage is that the coupling of various embodiments is specified in terms of magnetic flux, not a voltage level. By adjusting the turns-ratio of the plug winding, the supply voltage can be provided at any convenient level. The windings may be selected to develop the specified magnetic flux density at the mating surface. Likewise, the vehicle is not constrained to any particular internal voltage, and any charger can inherently work with any vehicle, despite the internal voltage differences that may be present between vehicles.

Embodiments provide a plug coupler that is cylindrical with a spherical mating surface, assuring a solid connection even if the plug is slightly misaligned. The cylindrical profile of the plug housing allows the plug to be rotated with respect to the vehicle mating socket. This feature simplifies coupling if the vehicle parking surface is tilted. Also, the mating receptacle entrance may be tapered to prevent jamming.

The high-frequency power signal provided to the plug does not provide a source that may electrocute or shock a user, unlike 60-Hertz power. Magnetic components scale inversely as a function of frequency making a high-frequency magnetic coupling much smaller than the 60-Hertz equivalent. The high frequency of operation allows a small, inexpensive inductively coupled plug to handle high power levels to rapidly charge a vehicle battery. A standard household extension cord is limited to 1,800 Watts, and the previously discussed Magnecharger, operating from a dedicated 230-Volt connection can supply 4,600 Watts, that is less during operation due to losses in the charging circuitry. In several embodiments described herein, a charger is provided that can operate at high frequency with standard wiring and can supply 12,000 Watts without excessive currents or dangerous voltages. The 12,000-Watt coupling capability allows vehicle batteries to be charged in minutes instead of hours. Furthermore, in some embodiments a solar collector is provided, and by connecting the vehicle directly to the solar collector's inverter, the high frequency inverter output does not have to be converted to 60-Hertz, thereby reducing the cost and complexity of such a component.

In one aspect, a vehicle is pulled to a charging station that provides an automatic connection of an inductive charger between the charging station and the vehicle. Some embodiments include a visual indicator that a vehicle operator may use to properly align the vehicle to the charging station. Such a visual indicator may include optical beams to visually position the vehicle for automatic connection of the charger plug. Such automatic, autonomous charger connection will be attractive to many vehicle operators, encouraging electrical vehicle usage by decreasing the manual tasks otherwise required. The light beam used for vehicle alignment, in some embodiments, is digitally encoded with additional information such as the user's desire to buy or sell battery energy and the height of the charger receptacle of the vehicle. At the vehicle operator's option, the beam can also pass credit card, or other payment, information to the operators of public parking spaces, relieving the vehicle operator from manually inserting cash or coins into marking meters, pay stations, etc. Other embodiments provide a bi-directional communication link in the charger coupling that allows, for example, a user to call their vehicle on their cell phone to start the air-conditioning as they prepare to leave a location. Conversely, a vehicle alarm system could notify the driver by cell phone if there was an indication of tampering.

Embodiments described herein provide a number of advantages, such as decades of household electrical energy for most, if not all, of the vehicle's fuel. Embodiments also provide that many drivers will seldom need to stop at a filling station. In addition, solar collectors and the vehicle battery could be used to provide emergency power should the power grid fail. If, for instance, natural disaster victims have plug-in vehicles with a bi-directional plug, they may be able to use their vehicle to supply emergency power for refrigerators, cell phones, radios, lights, etc. The inductive plug of various embodiments would continue to work even if covered by floodwaters.

### BRIEF DESCRIPTION OF THE DRAWINGS

FIG. 1 is an illustration of a plug of a US standard extension cord.

FIG. 2 is an illustration of the General Motors Magnecharger for charging the battery of the discontinued EV-1 electric vehicle.

FIG. 3 is a side view illustration of a plug-in vehicle in an owner's garage about to receive the inductive coupling of an embodiment.

FIG. 4 is a side view of a vehicle in a public parking space with an overhead solar collector of another embodiment.

FIG. 5A is a view as seen by the driver of the alignment target with a visual alignment aid positioned off to the right indicating the vehicle is not aligned to receive the charger coupling in an embodiment.

FIG. 5B is a plan view of the misaligned vehicle corresponding to FIG. 5A.

FIG. 6A is a view of the visual alignment target before the vehicle is close enough for the charger coupling to connect for an embodiment.

FIG. 6B is a plan view of an aligned vehicle corresponding to FIG. 6A.

FIG. 7A is a view showing a visual alignment aid with both the alignment beam and the proximity beam centered on the alignment target for an embodiment.

FIG. 7B is a plan view of a properly positioned vehicle ready to receive the charger coupling for an embodiment.

FIG. 8A is a view of the alignment target with more detail for an embodiment.

FIG. 8B is a view of the alignment target of FIG. 8A indicating the alignment beam has been detected.

FIG. 8C is a view of the alignment target of FIG. 8A indicating a properly positioned and connected vehicle.

FIG. 8D is a view of a public parking space target rejecting a non-handicapped vehicle for parking in a handicapped space for an embodiment.

FIG. 9 is a cross-sectional view of the battery charger plug of an embodiment.

FIG. 10 is a cross-sectional view of the vehicle mounted charger receptacle of an embodiment.

FIG. 11 is a schematic view of the plug robotic guidance circuitry for an embodiment.

FIG. 12 illustrates a rectifier combining solar and grid power for an embodiment.

### DETAILED DESCRIPTION

The present disclosure recognizes that the current utility company power delivery model is based on centralized power plants with transmission and distribution lines to the power consumers. However, absent a significant, costly, and time-consuming upgrade, the existing transmission and distribution facilities cannot support the added load of an electrically powered transportation system, because of the additional demands that would be placed on the system. An alternate utility model is numerous individual producers that may be coupled with centralized power plants. According to this concept, rooftop photovoltaic (PV) collectors move the energy collection to where the energy is actually used, saving at least some of the expense of upgrading the utility grid. As is well known, wind and solar power is subject to uneven supply, and one economical way to store the energy to offset the uneven supply of wind or solar power is the batteries of plug-in electric, or plug-in hybrid vehicles.

The embodiments described herein provide charging plugs for a vehicle battery using magnetic induction in lieu of metallic contacts. Such embodiments provide a number of advantages such as listed above relative to inductive couplers, such as that the inductive coupler has no exposed contacts that could provide a safety hazard; there is no exposed metal to corrode, wear, or become contaminated; low or no force required to mate, simplifying plugging-in; and isolation of the vehicle electronics from the charger.

Various embodiments described herein are designed to operate with high frequency AC, eliminating the disadvantage of 60-Hertz components. Provide the advantage that the coupling is specified in terms of magnetic flux, not a voltage level, which provides that ability to adjust the turns-ratio of the plug winding to provide a supply voltage at any convenient level. The windings are selected to develop the specified magnetic flux density at the mating surface. Likewise, the vehicle of such embodiments is not constrained to any particular internal voltage, so any charger can inherently work with any vehicle, despite the internal voltage differences between vehicles. The high-frequency power signal of the inductive coupler provided in embodiments cannot electrocute or even shock, unlike 60-Hertz power. Magnetic components scale inversely as a function of frequency making a magnetic coupling much smaller than the 60-Hertz equivalent, and thus high frequency of operation allows a relatively small, inexpensive inductively coupled plug to handle high power levels to rapidly charge a vehicle battery. In some embodiments, the charger can operate at high frequency to allow standard wiring to supply 12,000 Watts without excessive currents or dangerous voltages, and can use standard household wiring. Such 12,000-Watt coupling capability allows vehicle batteries to be charged in minutes instead of hours.

Some embodiments provide for the use of rooftop photovoltaic (PV) solar collectors to supply household electricity, to charge the battery of a plug-in vehicle, and to sell the excess energy to the utility grid for other users. Even with modestly efficient solar cells, there is commonly enough roof area of even a small residence to supply power for all of these uses. If the connection to the hybrid vehicle is bi-directional, the excess capacity of the vehicle battery can supply external power when no power is available from wind or solar radiation sources.

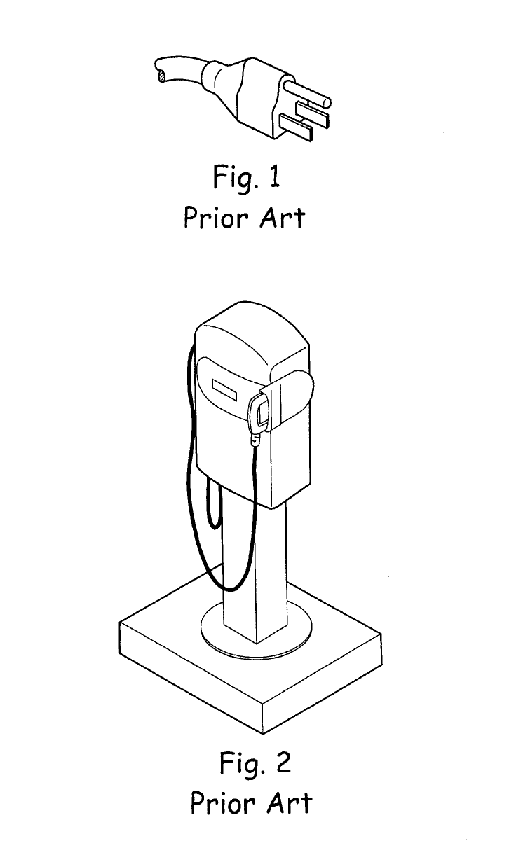

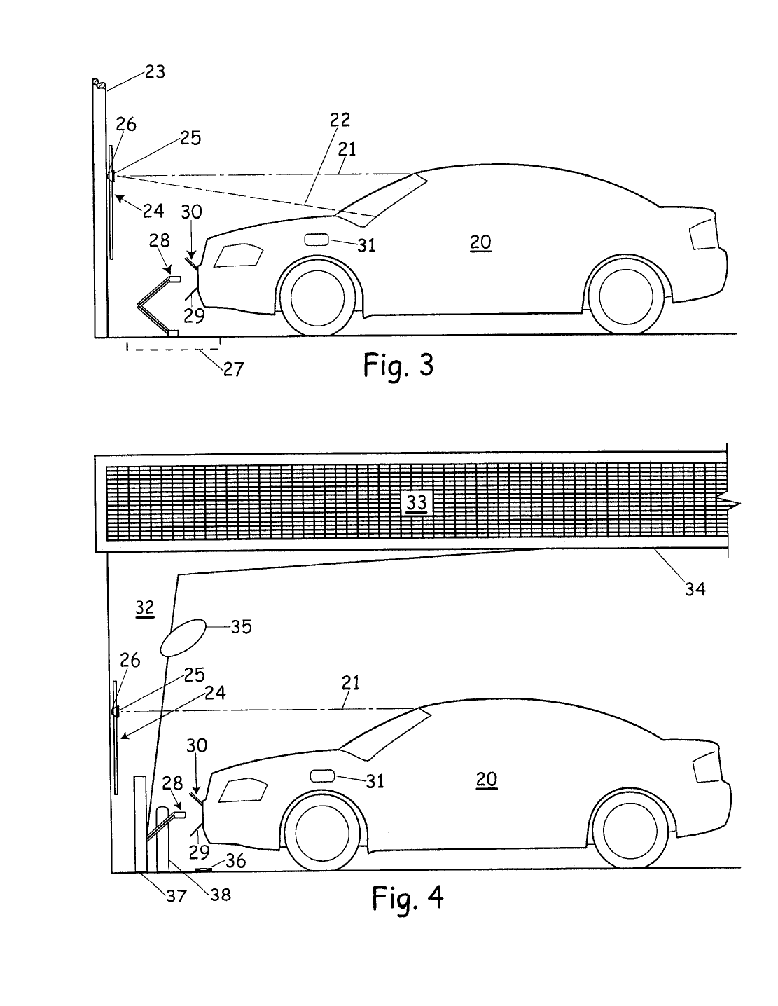

With reference now to the drawings, FIG. 1 shows a standard plug commonly used to charge electric vehicles in the United States as prior art. FIG. 2 is an illustration of the General Motors Magnecharger as prior art. FIG. 3 is an illustration of one embodiment of the present disclosure sited in a vehicle owner's garage, for example. Here, a vehicle 20 faces a back wall 23 of the garage. Mounted on the back wall 23 is a laser target assembly 24 containing a Fresnel lens 25 and behind the Fresnel lens 25 is a photodetector and demodulator 26. Positioned at a convenient place on the vehicle 20 is an access door 31 covering a receptacle for a standard extension cord. An alignment beam 21 and a proximity beam 22 emanate from the front of the vehicle 20, toward the laser target assembly 24. Mounted at the extreme front of the vehicle 20 is an outer door assembly 30 and an inner door 29, aligned near an inductive coupling plug assembly 28. The plug assembly 28 is shown extended from a below-grade robotic arm compartment 27.

FIG. 4 illustrates another embodiment shown here as a public parking facility, although similar configurations may be used in private or residential applications. In this embodiment, the vehicle 20 has an alignment beam 21, access door 31, outer door assembly 30 and an inner door 29, as described previously with respect to FIG. 3. In this embodiment the vehicle 20 is parked below a carport roof 34 held over the parking space by a support structure 32. On the carport roof 34 is a bank of photovoltaic solar cells 33. Also mounted on the support structure 32 is the laser target assembly 24 and a mirror 35 visible to the vehicle driver, providing a view of a proximity alignment target 36. In such a manner, a vehicle operator may view the alignment target 36 in the mirror 35, and pull the vehicle 20 up to the appropriate alignment such that the plug assembly 28 couples with the vehicle 20 recharging port. A crash protection pylon 38 prevents damage to the support structure 32 if the vehicle 20 fails to stop when parking. In this embodiment, the plug assembly 28 is mounted in an above-grade robotic arm compartment 37. In other embodiments, a portable assembly of target assembly 24, actuator compartment 37, and robotic plug assembly may be used for situations where no garage or suitable structure is available.

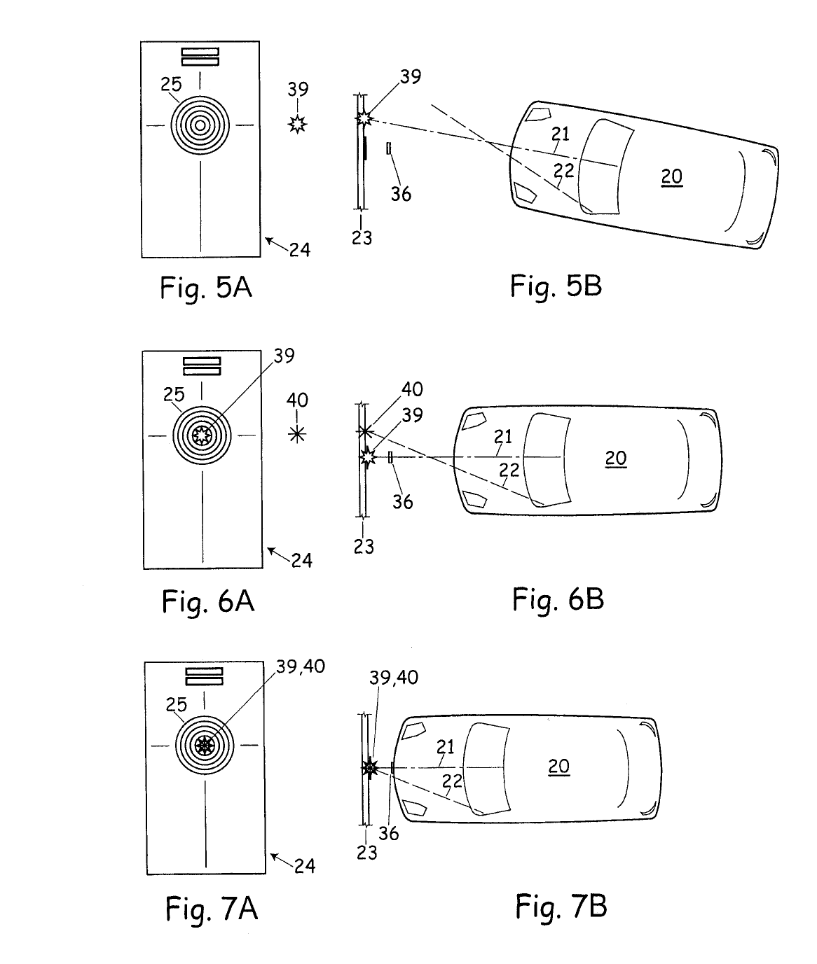

As discussed above, in some embodiments the vehicle 20 produces two optical beams that are used as aids to properly position the vehicle 20 in the parking spot and relative to the charger and plug assembly 28. FIGS. 5A, 6A, and 7A are views from a driver's position of such embodiments as the vehicle 20 is maneuvered into position for coupling with the plug assembly 28. In this embodiment, a Fresnel lens 25 is used as a target, and is visible on the target assembly 24. The vehicle 20 produces two optical outputs, an alignment bean 21, and a proximity beam 22. FIG. 5A has an alignment spot 39 from the alignment beam 21, which in one embodiment is a modulated laser beam, visible to the right of the target 24. The front of the vehicle 20 is some distance away from the horizontal proximity target 36. FIG. 5B, a plan view of the approaching vehicle 20, shows the alignment spot 39 to be striking the wall 23 and not centered on the target 24 because of the misalignment of the vehicle 20. In FIG. 6A, the alignment spot 39 from beam 21 is centered on the lens 25 because the vehicle is properly aligned as directly facing the target 24. However, the second visible spot, proximity spot 40, from proximity beam 22 is to the right of the target 24, indicating that the vehicle 20 needs to be pulled closer to the wall 23. Plan view FIG. 6B again shows the alignment spot 39 centered on the target 24 and the proximity spot 40 to the right of center because the vehicle 20 is not fully in position but is closer to the horizontal proximity target 36. FIG. 7A shows both the alignment spot 39 and the proximity spot 40 converged on the center of the target 24. FIG. 7B is consistent with FIG. 7A with both alignment beam 21 and the proximity beam 22 converged on the center of the target 24. The front of the vehicle 20 partially covers proximity target 36 when the vehicle 20 is fully in position.

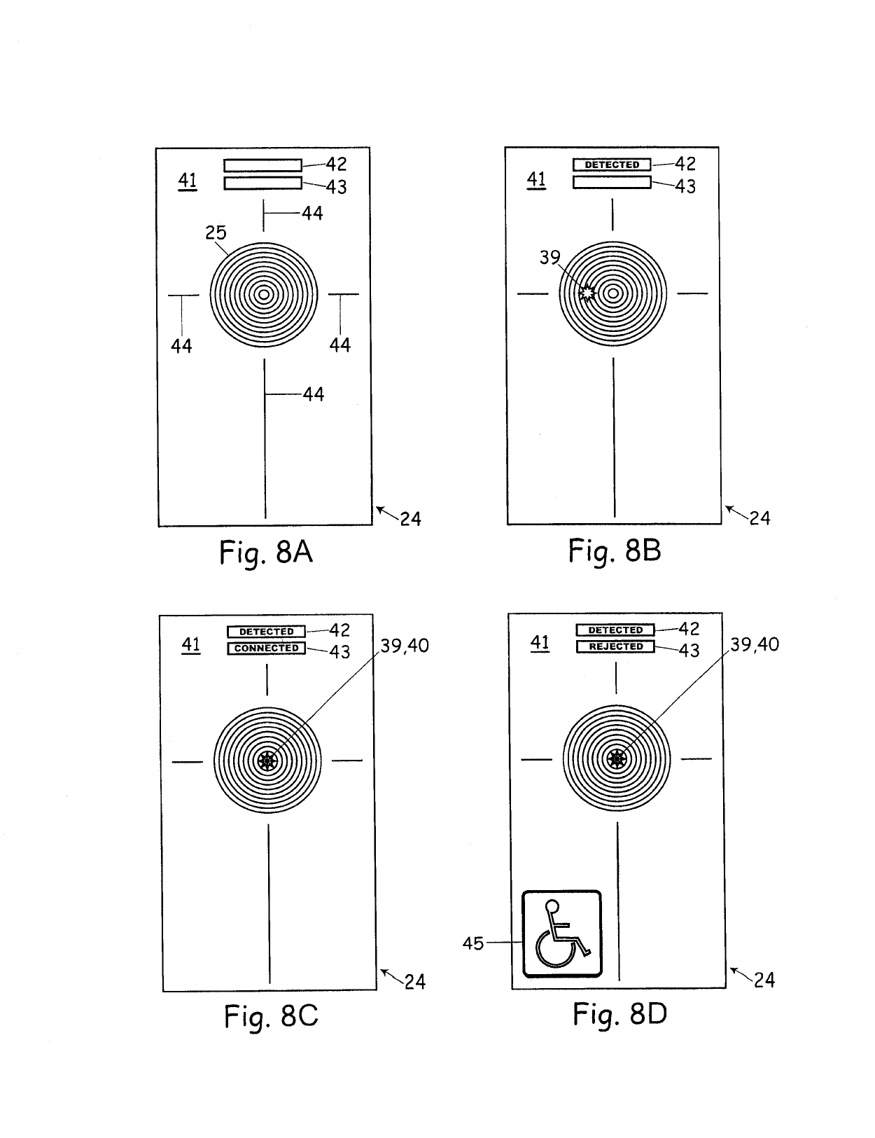

FIG. 8A is one of four larger illustrations of the alignment target 24 of an embodiment. The Fresnel lens 25 of this embodiment is centered vertically, surrounded by a reflective background 41. Fiducial marks 44 radiate out from around the lens 25 to assist in centering the alignment beams 39, 40. A beam detection indicator 42 and a connection status indicator 43 are shown as blank in this figure. FIG. 8B shows the alignment spot 39 striking the lens 25. Here, the indicator 42 indicates that the beam 39 has been sensed by the detector 26 by displaying the word “DETECTED.” In FIG. 8C, both of the beams 39, 40 have converged indicating that the vehicle 20 is properly aligned and positioned properly, with indicator 42 showing that the alignment beam 39 was detected and that the coupling was successfully completed as indicated by the displayed message, “CONNECTED,” on the indicator 43. FIG. 8D shows an example of the alignment target used in a public handicapped parking space of an embodiment. This target 24 also has a handicapped symbol 45 indicating that the space is reserved for those registered as handicapped. In this embodiment, information modulated on the alignment beam 39 is received by the alignment target 24, such information including information relating to the particular vehicle's eligibility to park in a space that is reserved for handicapped. In the example of FIG. 8D, the vehicle does not have proper credentials, and the indicator 43 has the message “REJECTED.” Information communicated to/from a vehicle through alignment beam 39, or other types of communications, will be described in more detail below.

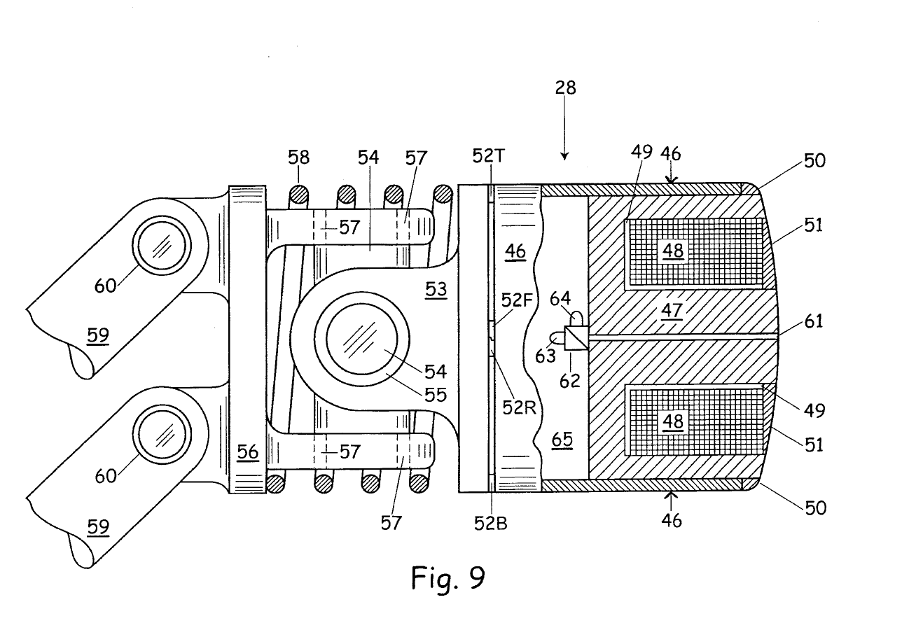

Referring now to FIG. 9, a cross-sectional view of a plug assembly 28 is illustrated for an embodiment. In this embodiment, robotic arm struts 59 elevate the plug assembly 28 into position to mate with the vehicle 20. The struts 59 remain parallel to each other as they elevate into position because of the arrangement a pair of pivotally attached bushings 60 that are journaled on a bracket 56. In turn, bracket 56 is pivotally attached vertically to a universal-joint spider member 54 journaled by a set of bushings 57 to the bracket 56. Likewise, the spider member 54 is pivotally attached to a pair of bushings 55 horizontally journaled to allow vertical rotation of a bracket 53. The bracket 53, in this embodiment, is attached to a plug housing 46 via four strain gauges, 52T, 52F, 52R, and 52B. The uppermost strain gauge 52T is located at the very top on the periphery of the bracket 53 and of the housing 46. Likewise, the other strain gauges 52F, 52R, and 52B are located peripherically around the bracket 53 and connected similarly at the front, rear, and bottom of the housing 46. Within the housing 46 are the magnetic components: a ferrite core 47, and an associated winding 48 and a bobbin 49 holding the winding 48. To simplify the drawing, provisions for cooling the magnetic components are not shown as such components will be readily known to one of skill in the art.

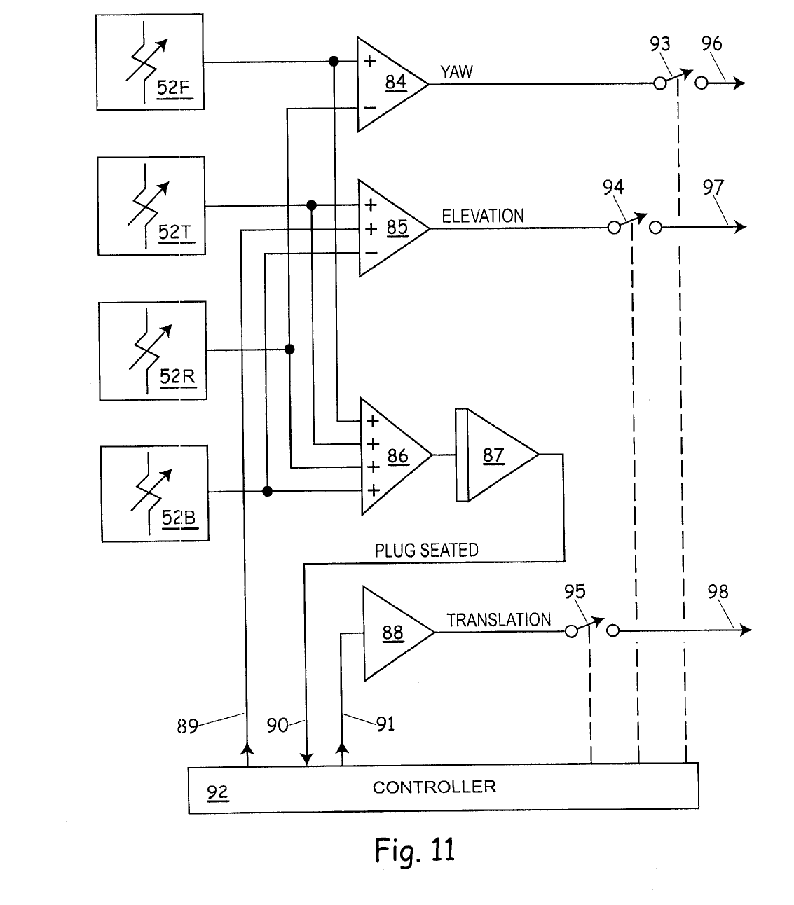

Having described the basic components associated with various embodiments, several exemplary embodiments of the operation of a charging station of the present disclosure are now described. With reference again to FIG. 3, the hybrid-electric or electric vehicle 20 is illustrated as parked in a garage or other parking space. In this view, the vehicle 20 is parked and is midway through the charger connection process. An exemplary hook-up sequence is as follows for a vehicle being parked in a private residence garage. First, while approaching the garage, the driver activates a standard garage door opener. The garage door opens in response to the garage door opener command, and in an embodiment the alignment beam 21 and proximity beam 22 are activated from optical sources located on the vehicle, and opens a cover that is associated with a charging receptacle located in the vehicle. In another embodiment, as the door opens, the driver presses another button to activate both the alignment beam 21 and the proximity beam 22. The alignment spot 39 from the alignment beam 21 shines on the garage back wall 23, illustrated in FIG. 5A. The alignment spot 39 provides a visual target for the driver to align the vehicle 20 with the charger plug 28. The driver simply steers to center of the alignment spot 39 on the bulls-eye appearing Frensel lens 25, which is part of the target assembly 24, and once aligned, the driver sees the alignment spot 39 centered on the Frensel lens 25 as illustrated in FIG. 6A. The alignment beam 20, in some embodiments, also transmits relevant digital information to a charger controller 92 (illustrated in FIG. 11) associated with plug assembly 28. The alignment spot 39, in this embodiment, does not have to be centered on the lens 25 and as long as the spot 39 is anywhere on the lens 25, information can be transmitted successfully. Similarly, the beam 21 does not have to be exactly perpendicular to the target 24 for satisfactory operation. The alignment beam 21 is focused by the Frensel lens 25 on to the photodetector 26. The acceptance angle of the lens 25 and detector assembly 26 matches the angular misalignment acceptable to the plug assembly 28 so that if the detector senses the digital information transmitted by the alignment beam 21, then the plug 28 is mechanically aligned well enough to mate with the vehicle 20. At this point the proximity beam 22 also casts a spot on the back wall 23. As the vehicle approaches the ideal distance into the garage, the proximity spot 40 moves closer to the Frensel lens 25 as indicated in FIG. 6A and FIG. 6B. When the vehicle 20 is close enough to connect to the charger plug, 28, the proximity spot 40 is also shining on the Frensel lens 25. FIG. 7A illustrates the superimposed alignment spot 39 and proximity spot 40 on Frensel lens 25. FIG. 7B shows the vehicle 20 ideally aligned for the charger plug 28 connection. Fiducial marks 44 help guide the driver to the proper vehicle location as seen in FIG. 8A. The alignment beam 21 in this embodiment is affixed horizontally to be aligned with the vehicle 20 centerline. The alignment beam 21 can be manually adjusted vertically by the driver to compensate for variations in the vehicle 20 height due to load variations, tire inflation, etc. It will be readily understood by one skilled in the art that various different alignment beams and alignment methods may be used to assist with the proper alignment of a vehicle as pulled into a parking space.

As briefly mentioned above, some embodiments, illustrated in FIG. 4, for example, provide a different type of indicator, such as a mirror, that can be used by a driver to determine the vehicle's position. In cases where the vehicle's 20 position is determined by an overhead mirror 35, the driver will observe the mirror and the proximity alignment target 36 located on the parking surface will be partially obscured by the front of the vehicle 20 when the vehicle 20 is moved into position for charging. This situation is illustrated in FIG. 4, where the vehicle is parked in a commercial parking space, for example. If the parking space is shaded as is illustrated in the example of FIG. 4, the overhead roof 34 may have a bank of photovoltaic solar cells 33 that can directly collect solar energy for use in charging vehicles. This arrangement saves the additional cost of transmission and distribution grid upgrades and also minimizes power losses. Such an arrangement, in appropriate situations, allows a driver to power his or her vehicle, at least partially, with energy from the sun. In FIG. 4, the charger plug assembly 28 is mounted vertically in an above-grade robotic arm compartment 37. The arm compartment 37 is protected from accidental parking damage by the robust pylon 38.

With reference now to the exemplary embodiment of FIGS. 8A, 8B, 8C, and 8D, the target 24 has a beam detection indicator 42 and a connection status indicator 43. The function of beam detection indicator 42 is to indicate to the driver that the vehicle 20 is aligned well enough to be sensed by the detector 26. The connection status indicator 43 indicates that the connection has been made only after the vehicle 20 is parked and the plug assembly 28 has fully mated with the vehicle 20, as illustrated in FIG. 8C.

As also mentioned above, the symbol 25 could be dynamically configured to adapt to varying handicapped space, or other authorized parking space, needs. Should a driver improperly park in a space, the indicator 43 would display a “REJECTED” message even if the vehicle 20 were properly aligned because the status or credentials of the vehicle 20 is encoded on the alignment beam 21. Such a situation is illustrated in FIG. 8D. Since credit information, in the form of a credit card number or other means, could, at the driver's choice, be transmitted to the detector 26, the space could be conveniently credited to a commercial parking lot without requiring a parking attendant or payment kiosks. If there was not sufficient credit in the driver's account, the indicator 43 could also display a “REJECTED” message.

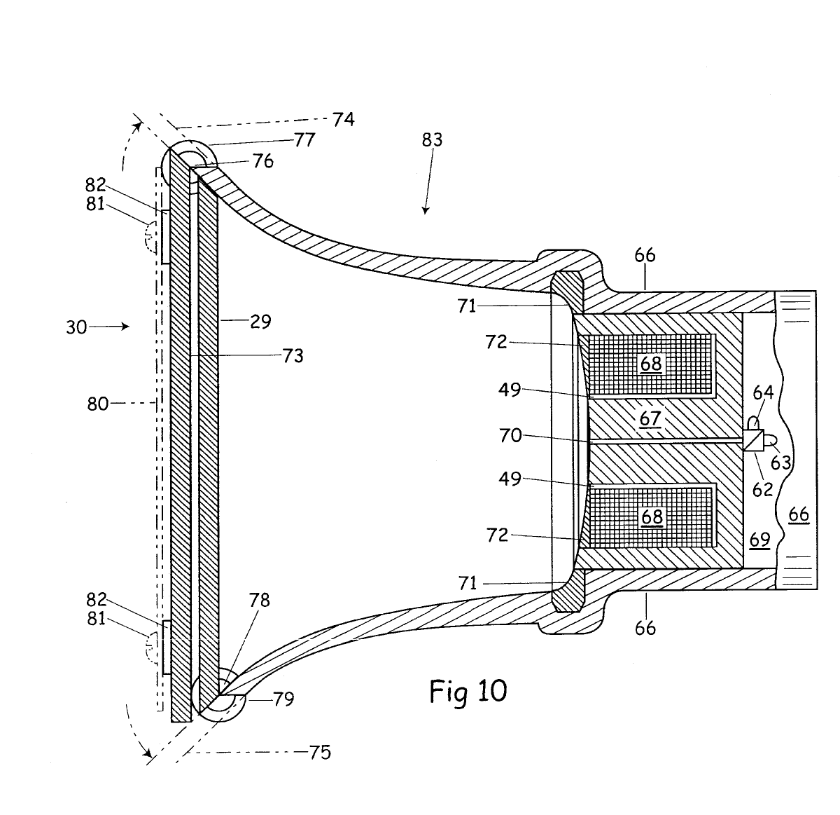

In one embodiment, until the driver has properly positioned the vehicle 20 and it is placed in park or otherwise properly positioned in the spot, all communication is one-directional from the vehicle to the detector 26. The driver placing the vehicle 20 in park causes an indication of that status to be encoded onto the alignment beam 21. Other information can be encoded as well, including the height of the vehicle receptacle 83, illustrated in FIG. 10. After sensing that the vehicle 20 is parked, the charger controller 92 activates the charger plug assembly to rise from its stowed position, such as a below-grade robotic arm compartment 27 or from an above-grade robotic arm compartment 37, for example. FIG. 3 and FIG. 4 show the plug assembly rising from the stowed position. The design of such robotic arms is well known in the art. If the vehicle needs to be charged in a location without this automated robotic plug assembly 28, a standard extension cord FIG. 1, could plug into the vehicle 20 under the charger plug door 31.

After the charger plug assembly 28 rises to the height of the vehicle receptacle 83, the plug assembly 28 translates horizontally in the direction of the vehicle 20 until contact is made with the vehicle receptacle.

FIG. 9 is a cross-sectional view of the plug assembly 28. Robotic arm struts 59 elevate the plug assembly 28 into position to mate with the vehicle 20. The struts 59 remain parallel to each other as they elevate into position because of the arrangement a pair of pivotally attached bushings 60 that are journaled on the bracket 56. This arrangement keeps the plug assembly 28 oriented parallel to the floor. In turn, bracket 56 is pivotally attached vertically to the universal joint spider member 54 journaled by the bushings 57 to the bracket 56. Likewise, the spider member 54 is pivotally attached to the bushings 55 and horizontally journaled to allow vertical rotation of the bracket 53. This universal-joint arrangement allows the plug assembly 28 to adjust angularly if the vehicle 20 is slightly misaligned when parked.

The bracket 53 is attached to a plug housing 46 via four strain gauges, 52T, 52F, 52R, and 52B. These strain gauges sense pressure if the plug assembly 28 is slightly off-center with respect to plug receptacle 83 and contacts the sides of the bell shape opening of the plug receptacle 83 of FIG. 10. If this happens, the robotic controller 93 drives the arms 59 into align. Prior to any contact, spring 58 keeps the plug assembly 28 straight.

Within the housing 46 are the magnetic components: the ferrite core 47, with associated winding 48 and bobbin 49. These magnetic components follow conventional design practices for ferrite core transformers. These three components, the ferrite core 47, associated winding 48, and bobbin 49 form the primary side of power transformer. When plug assembly 28 is mated with the plug receptacle 83, the two components comprise a ferrite core transformer. A silicon carbide wear plate 51 and silicon carbide wear ring 50 protect the ferrite core 47 from damage. The convex surface formed by ferrite core 47, plate 51, and ring 50 matches the concave mating surface of the receptacle 83.

With continuing reference to FIG. 9, a cavity within the housing 46 forms the electronics compartment 65. This compartment 65 contains strain gauge amplifiers and various connectors for power and signal leads (not shown). Also, in this embodiment, within this compartment 65 are LED 63, photo diode 64 and beam splitter 62 which allow bi-directional communication through lightpipe 61 so that digital information can be exchanged between the charger plug 28 and corresponding components within the receptacle 83.

FIG. 10 details the structure of receptacle 83 for an exemplary embodiment. The magnetic components, ferrite core 67, bobbin 49, winding 68, wear ring 71, and wear plate 72 function as the corresponding components in charger plug 28. The convex outer surface of those components allows a very slight misalignment between the charger plug 28 and the receptacle 83. The tapered entrance of the housing 83 guides the charger plug 28 into a constricted opening as the two components mate. The diameter of the opening, even near the constricted end, is slightly larger than the plug 28 diameter, so the plug is unlikely to bind in the receptacle if diameters vary with temperature or other causes. This loose fit does not assure absolute angular alignment of the plug 28, and the curved faces accommodate slight misalignment.

The spring-loaded flexible joint of the charger plug 28 accommodates larger angular misalignments between the charger plug 28 and the vehicle 20. The receptacle housing 66 has a cavity for the receptacle electronics compartment 69. The electronics compartment 69 contains strain gauge amplifiers and various connectors for power and signal leads (not shown) as well as LED 63, photo diode 64, and beam splitter 62 which allow bi-directional communication through lightpipe 70 in the same manner as the corresponding components in the charger plug assembly 28. Information transmitted over this optical link may include the state of the vehicle 20 battery charge, whether the operator wants to sell energy within the battery, or conversely, to charge the battery.

The magnetic components in the charger plug 28 and the receptacle 83 are sized to handle substantially identical amounts of power. However, the number of turns in the charger plug winding 48 and the number of turns in the receptacle winding 68 do not have to match. This means the operating voltage of the charger plug assembly 28 and the vehicle voltage can be independently optimized and still be consistent with a single universal standard.

In the exemplary embodiment of FIG. 10, the end of receptacle housing 66 opposite the magnetic components is covered by two rectangular doors 29, 73 when the vehicle is not being charged. The doors 29, 73 are approximately the same dimensions as an US license plate. Outer door 73 is pivotally attached to activating shaft 76, journaled in bushing 77. Similarly, inner door 29 is pivotally attached to shaft 79, journaled in bushing 79. Both door shafts 76, 78 are operated by motor activators (not shown) similar to the well known automotive activators used to open headlight doors, etc. The door opening sequence begins when the vehicle operator activates the alignment beam 21. This would typically occur well before the vehicle 20 is parked. The outer door 73 opens as indicated by position 74. This position 74, allows the door 73 to act both as a guide for the plug 28 and a mount for the vehicle license plate 80. After the outer door 73 is opened, inner door 29 opens to the position 75 shown in FIG. 10. With both doors 29, 73 open, there is a capture area of approximately 12″ horizontally by 14″ vertically. The horn shaped opening of the housing 66 transitions from the rectangular shape of the license plate 80 to the round cross-section of the ferrite core 67 to guide the ferrite core 47 of the plug 28 to align with the ferrite core 67 of the receptacle 83.

Once the alignment beam 21 transmits the code to the detector 26 that the vehicle is parked, the robotic arm controller 92 causes the robotic arms 59 to raise the plug assembly 28 to the height of the receptacle 83. Once the plug is at the desired height, a servo mechanism within the robotic arm controller 92 drives the plug 28 toward the vehicle receptacle 83 until the plug 28 contacts the receptacle 83. The strain gauge sensors 52 detect contact with the receptacle 83 walls and drive the servo mechanism to correct the plug path until the plug 28 is fully mated in the receptacle 83. The fully mated position is detected by pressure being sensed by all of the strain gauge sensors 52 which, in this embodiment, activates the optical communications channel between the plug 28 and receptacle 83. After the plug 28 is fully mated, the optical interface is activated to establish transferring charge/discharge, and/or other information, between the charger and vehicle.

FIG. 11 illustrates controller 92 and associated circuitry for an exemplary embodiment. The elevate signal line 89 from the controller 92 feeds into the elevation amplifier 85. At this stage of the connection process, the elevation switch 94 from the elevation amplifier 85 is commanded closed by the controller 92. Thus the elevation signal from elevation switch 94 is connected to the elevation amplifier drive signal 97 and the robotic arm 59 rises to the height of the receptacle 83. Once at the correct height, signal 89 from the controller 92 becomes inactive to halt the arm 59 elevation. During the interval while the arm 59 is rising, yaw switch 93 is also commanded closed by the controller 92, but no drive signal is on the yaw drive line 96 because there is no output from yaw amplifier 84. Likewise, the translation switch 95 is closed and, similarly, no signal is applied to translation drive line 98 because there is no output from the translation amplifier 88. Once the plug 28 has been elevated to the mating height, the controller 92 applies a translation signal to the translation amplifier 88 through controller output 91. This signal from the translation amplifier 88 through closed switch 95 to the translation drive line 98, causes the plug assembly 28 to move toward receptacle 83. If the plug 28 makes contact with the sidewalls of the housing 66 before fully mated, strain gauges 52F and 52R provide differential signals into the yaw amplifier 84 to drive the servo arm 59 to center the plug 28 horizontally. Likewise, if the plug 28 makes contact with the open upper door 74, open lower door 75, or the top or bottom of the housing 66, strain gauges 52T and 52B provide differential signals to elevation amplifier 85 to center the plug 28 vertically. Once the plug is fully seated, the building pressure is sensed by the four strain gauges 52T, 52R, 52R, and 52B equally. Those outputs are summed with the plug seated amplifier 86. When the output of the amplifier 86 reaches the predetermined threshold corresponding to the desired seating pressure, that level causes the threshold detector 87 to signal that the plug is seated via the plug seated signal line 90. Once the controller 92 senses the active signal on the line 90, the controller 92 commands switches 93, 94, and 95 to open, thus stopping all drive to the robotic arms 59.

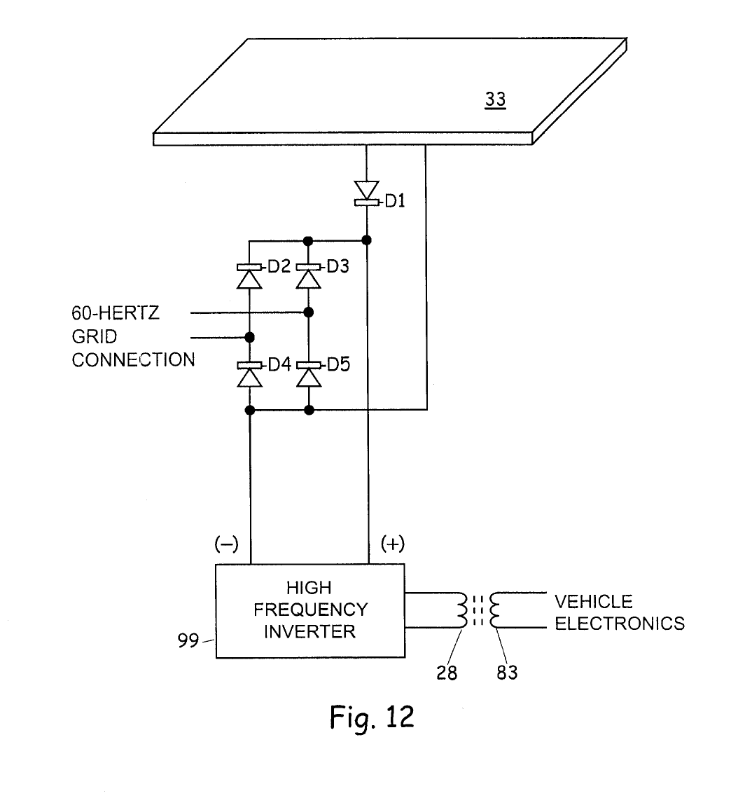

With reference now to FIG. 12, an exemplary embodiment is described in which a power arrangement avoids having to convert DC voltage from a solar panel 33 to 60-Hertz AC, and thus avoid a major expense associated with an inverter. In this example, 60-Hertz AC from the grid is rectified by diodes D2, D3, D4, and D5 to directly power the high frequency inverter 99 when the solar panel 33 is inactive. When sunlight strikes the solar panel 33, that current is applied to the high frequency inverter 99 through diode D1, overriding the grid connection.

While the above descriptions contain many specificities, these should not be construed as limitations on the scope of the invention. Other variations are possible. For instance, other methods of aligning the vehicle 20 could be used as long as the vehicle 20 was positioned accurately to receive the plug assembly 28. Methods other than modulating a light beam could be used to exchange information between the vehicle 20 and the charging facility. For example, information could be transmitted via RF, inductive coupling, ultrasonic waves, modulation of the charging waveform, and infrared light. The information transmitted is not limited to the descriptions of the described embodiments. Other types of covering for the vehicle receptacle are possible including using a single door or no door at all, are within the scope of the invention. Other locations for the vehicle receptacle, for instance under the vehicle, will work if the coupling can be completed. Likewise, other methods of guiding the plug assembly 28 can be used within the scope of the present invention. Some embodiments described herein use a robotic drive to translate the plug assembly 28 to mate with the vehicle. However, the forward motion of the vehicle could be used to couple the stationary plug assembly 28 into the vehicle receptacle.

The previous description of the disclosed embodiments is provided to enable any person skilled in the art to make or use the present invention and the currently known best mode. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A charging apparatus for connecting a vehicle to an external power source, the vehicle having a battery that is capable of being charged from the external power source and having a receptacle configured to receive a plug connected to the external power source, comprising:
an alignment target that receives at least one visual alignment beam from a vehicle, the position of the alignment beam providing visual indication to a vehicle operator that the vehicle is properly aligned relative to said target;
an arm mounted to a structure and having a plug at a distal end thereof, said plug interconnected to the external power source and adapted to engage the vehicle receptacle and transfer power to the vehicle; and
a module for controlling said arm such that said plug engages with the vehicle receptacle when the vehicle is properly aligned relative to said target.

2. The charging apparatus of claim 1, wherein the alignment target includes a receiver that receives information from the vehicle comprising receptacle height information.

3. The charging apparatus of claim 2, wherein said receiver is operable to receive information related to vehicle credentials related to authorization of the vehicle to park in a space associated with the charging apparatus.

4. The charging apparatus of claim 2, wherein said receiver is operable to receive information related to vehicle payment information related to required payment for the vehicle to park in a space associated with the charging apparatus.

5. The charging apparatus of claim 2, wherein said arm includes a communication receiver is operable to receive information related to vehicle credentials related to authorization of the vehicle to park in a space associated with the charging apparatus.

6. The charging apparatus of claim 1, wherein said plug is adapted to transfer power to or from the vehicle.

7. The charging apparatus of claim 1, wherein said plug comprises a primary side of a power transformer adapted to be engaged with a secondary side of a power transformer associated with the vehicle receptacle, and when engaged completes a magnetic core power transformer interconnected to the external power grid and adapted to transfer power to the vehicle.

8. The charging apparatus of claim 7, wherein a turns ratio of the primary and secondary sides of the power transformer are selected based on a charging/discharging voltages associated with the vehicle and the charging apparatus.

9. The charging apparatus of claim 1, wherein said plug comprises a transmitter/receiver adapted to transmit/receive information to/from the vehicle through a corresponding transmitter/receiver in the vehicle receptacle.

10. The charging apparatus of claim 9, wherein said transmitter/receiver is an optical transceiver.

11. The charging apparatus of claim 9, wherein said transmitter/receiver transmits information to the vehicle to provide remote control of one or more vehicle functions.

12. The charging apparatus of claim 1, wherein said arm comprises at least one pressure sensor mounted adjacent to said plug that outputs a signal indicative of pressure that is applied to said plug, and wherein said signal is indicative of proper alignment between said plug and receptacle.

13. The charging apparatus of claim 1, wherein the external power source comprises a solar collector and high-frequency AC inverter, and wherein power is transferred to the vehicle at an AC frequency significantly higher than 60 Hz.

14. A vehicle receptacle assembly interconnected with at least one vehicle battery and adapted to receive a plug assembly to connect the vehicle to an external power source and charge the battery, comprising:
a horn-shaped guide surface having an opening with a first diameter and a rear surface with a second diameter, the second diameter smaller than the first diameter; and
a secondary side of a power transformer adjacent to said rear surface and adapted to be engaged with a primary side of a power transformer associated with the plug assembly, and when engaged completes a ferrite core transformer interconnected to an external power source.

15. The vehicle receptacle assembly of claim 14, wherein a turns ratio of the primary and secondary sides of the power transformer are selected based on a charging/discharging voltage associated with the vehicle.

16. The vehicle receptacle assembly of claim 14, further comprising a transmitter/receiver interconnected to said rear surface that is adapted to transmit/receive information to/from the vehicle through a corresponding transmitter/receiver in the plug assembly.

17. The vehicle receptacle assembly of claim 14, wherein said transmitter/receiver is an optical transceiver.

18. The vehicle receptacle assembly of claim 17, wherein said transmitter/receiver receives information from the plug assembly that provides instructions related to control of one or more vehicle functions.

19. The vehicle receptacle assembly of claim 14, further comprising a cover plate mounted adjacent to said horn-shaped guide surface and movable to cover said opening when the vehicle is not to be charged.

20. The vehicle receptacle assembly of claim 14 integrated with a vehicle license plate mounting.

21. A method of charging/discharging a battery in vehicle at least partially powered by a battery, comprising:
providing an optical target associated with a charging apparatus;
receiving one or more visual beams from the vehicle at the optical target;
detecting that the vehicle is aligned in the charging position;
moving a plug assembly to engage with a vehicle receptacle; and
when the plug assembly is engaged with the vehicle receptacle, charging or discharging the battery.

22. The method as in claim 21, wherein said step of moving comprises:
receiving information related to a receptacle height of the vehicle;
adjusting a height of the plug assembly based in said receptacle height information; and
extending the plug assembly to engage with the vehicle receptacle.

23. The method as in claim 22, wherein said step of extending comprises:
receiving a signal from at least one pressure sensor in the plug assembly; and
adjusting at least one of elevation and yaw of the plug assembly based on the signal.
